(19) United States
(12) Patent Application Publication
(10) Pub. No.: US 2018/0029101 A1
(43) Pub. Date: Feb. 1, 2018

(54) Multiple Bay Staging Assembly for a Shell Press Assembly

(71) Applicant: Stolle Machinery Company, LLC, Centennial, CO (US)

(72) Inventors: Robert Dean Turnbull, Massillon, OH (US); Brent Allen Young, Massillon, OH (US); Edward Eugene Donaldson, North Canton, OH (US)

(73) Assignee: Stolle Machinery Company, LLC, Centennial, CO (US)

(21) Appl. No.: 15/223,345

(22) Filed: Jul. 29, 2016

(51) Int. Cl. B21D 22/02; B65G 59/02

(52) U.S. Cl. CPC B21D 22/02; B65G 59/02; B65G 2207/40; B65G 2814/031

(57) ABSTRACT

A staging assembly for a shell press assembly sheet feeder assembly is provided. The shell press assembly includes an infeed and the sheet feeder assembly. The sheet feeder assembly includes a feeder actuator. The feeder actuator has a first path and a second path. The staging assembly includes a staging assembly frame assembly. The staging assembly frame assembly defines a first sheet bay and a second sheet bay. The first sheet bay is structured to temporarily support a first number of material sheets. The second sheet bay structured to temporarily support a second number of material sheets.

### BACKGROUND OF THE INVENTION

### Field of the Invention

The disclosed and claimed concept relates to a shell press assembly and, more particularly, to a staging assembly for a shell press assembly sheet feeder assembly. A method of using the shell press assembly sheet feeder assembly is also disclosed.

### Background Information

Metallic containers (e.g., cans) for holding products such as, for example, food and beverages, are, in one exemplary embodiment, provided with an easy open can end on which a pull tab is attached (e.g., without limitation, riveted) to a tear strip or severable panel. The severable panel is defined by a scoreline in the exterior surface (e.g., public side) of the can end. The pull tab is structured to be lifted and/or pulled to sever the scoreline and deflect and/or remove the severable panel, thereby creating an opening for dispensing the contents of the can. Other can ends, such as, but not limited to, a can bottom or a sanitary food end, do not include a rivet and/or pull tab. Further, as is known, cans are initially formed from a planar blank that is made into a cup before being formed into an elongated can body. Thus, most elements of a can are initially created from generally planar metal sheets. The following uses a can end as an example, it is understood that the following is applicable to any can elements formed from a planar sheet.

When the can end is made, it originates as a can end shell, which is formed from a blank cut (e.g., blanked) from a metal material sheet (e.g., without limitation, sheet aluminum; sheet steel) in a shell press assembly. The shell press assembly includes an infeed structured to move the material sheet from outside the shell press assembly to the work stations within the shell press assembly.

At one time, sheets of material were fed into the shell press assembly manually. Today it is more common that the material sheet is provided to the shell press assembly infeed by a sheet feeder assembly. The sheet feeder assembly includes an actuator and a staging assembly. The actuator moves the material sheet from the staging assembly to the shell press assembly infeed. That is, the staging assembly includes a sheet bay structured to temporarily support a number of material sheets. The actuator, such as, but not limited to a conveyor with a gripping assembly, moved the material sheets from the sheet bay to the shell press assembly infeed. Advances in robotics have allowed for a robotic arm to feed the material sheets to the shell press assembly infeed.

The disadvantage to the known sheet feeder assembly, or the staging assembly, is that the actuator is deactivated during the time the material sheets are moved into the sheet bay. That is, it could be dangerous for the actuator to be operative as technicians were in close proximity thereto. Further, when the sheet feeder assembly is not operative, the shell press assembly is also inactive. Thus, each time when a sheet bay became empty, or if the sheets within the sheet bay were found to be defective, the shell press assembly was inactive. Further, some sheet feeder assembly, or staging assemblies, were not disposed immediately adjacent the associated shell press assembly. In this configuration, the material sheets were moved across a space that people could walk through. This could be dangerous as a person in the path of travel of the material sheets and/or a robotic arm could be injured by the material sheet or moving feeder elements. This problem is notable when moving material sheet in that the material sheet occupies a greater area than, for example, a stack of cups.

### SUMMARY OF THE INVENTION

At least one embodiment of the disclosed and claimed concept provides a staging assembly for a shell press assembly sheet feeder assembly. The shell press assembly includes an infeed and the sheet feeder assembly. The sheet feeder assembly includes a feeder actuator. The feeder actuator has a first path and a second path. The staging assembly includes a staging assembly frame assembly. The staging assembly frame assembly defines a first sheet bay and a second sheet bay. The first sheet bay is structured to temporarily support a first number of material sheets. The second sheet bay is structured to temporarily support a second number of material sheets.

In this configuration, the feeder actuator is structured to move material sheet from one bay at a time to the shell press assembly infeed. While the feeder actuator interacts with one sheet bay, the other sheet bay may be loaded. For example, if the feeder actuator is moving material sheet from the first sheet bay, the technicians load new material sheet into the second sheet bay. When the first sheet bay empties (or if the material sheet therein is found to be defective) the feeder actuator begins to move material sheet from the second sheet bay. During this time, the material sheet is supplied to the first sheet bay. The disclosed apparatus and method is limited to a sheet feeder assembly for material sheets and excludes an apparatus and method for smaller constructs such as cups or containers/boxes. That is, when moving smaller constructs such as cups or containers/boxes, a feeder actuator moves over a relatively smaller path. Thus, the need for separate staging bays is reduced.

In this configuration, the shell press assembly remains in constant operation. Further, the configuration of the staging assembly, as well as the sheet feeder assembly, discussed below solves the problems stated above.

### BRIEF DESCRIPTION OF THE DRAWINGS

A full understanding of the invention can be gained from the following description of the preferred embodiments when read in conjunction with the accompanying drawings in which:

FIG. 1 is an isometric view of a sheet feeder assembly with a multi-bay feeder actuator disposed over a first sheet bay.

FIG. 2 is a top view of a sheet feeder assembly with a multi-bay feeder actuator disposed over a first sheet bay.

FIG. 3 is an isometric view of a sheet feeder assembly with a multi-bay feeder actuator disposed over a staging bay.

FIG. 4 is a top view of a sheet feeder assembly with a multi-bay feeder actuator disposed over a staging bay.

FIG. 5 is an isometric view of a sheet feeder assembly with a multi-bay feeder actuator disposed over a second sheet bay.

FIG. 6 is a top view of a sheet feeder assembly with a multi-bay feeder actuator disposed over a second sheet bay.

FIG. 7 is a flow chart of the disclosed method.

### DESCRIPTION OF THE PREFERRED EMBODIMENTS

The disclosed concept will be described as applied to can ends, although it will become apparent that they could also be employed to move/transfer material sheets to cupper or any known or suitable can bodymaker (e.g., without limitation, for beverage/beer cans, food cans). The disclosed concept is not structured to move/transfer “cups” as that term in used in the container bodymaking industry.

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “temporarily disposed” means that a first element(s) or assembly (ies) is resting on a second element(s) or assembly(ies) in a manner that allows the first element/assembly to be moved without having to decouple or otherwise manipulate the first element. For example, a book simply resting on a table, i.e., the book is not glued or fastened to the table, is “temporarily disposed” on the table.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, a “planar body” or “planar member” is a generally thin element including opposed, wide, generally parallel surfaces i.e. the planar surfaces of the planar member, as well as a thinner edge surface extending between the wide parallel surfaces. That is, as used herein, it is inherent that a “planar” element has two opposed planar surfaces. The perimeter, and therefore the edge surface, may include generally straight portions, e.g., as on a rectangular planar member, or be curved, as on a disk, or have any other shape.

As used herein, a “path of travel” or “path,” when used in association with an element that moves, includes the space an element moves through when in motion. As such, any element that moves inherently has a “path of travel” or “path.” When used in association with an electrical current, a “path” includes the elements through which the current travels.

As used herein, the statement that two or more parts or components “engage” one another shall mean that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality).

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

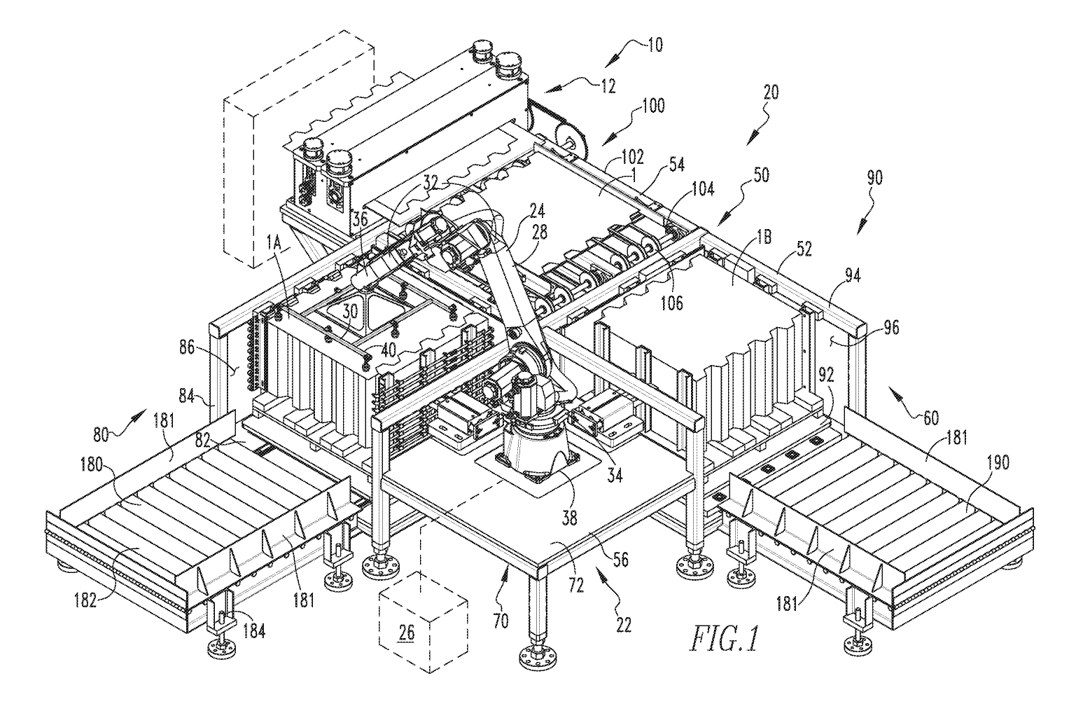

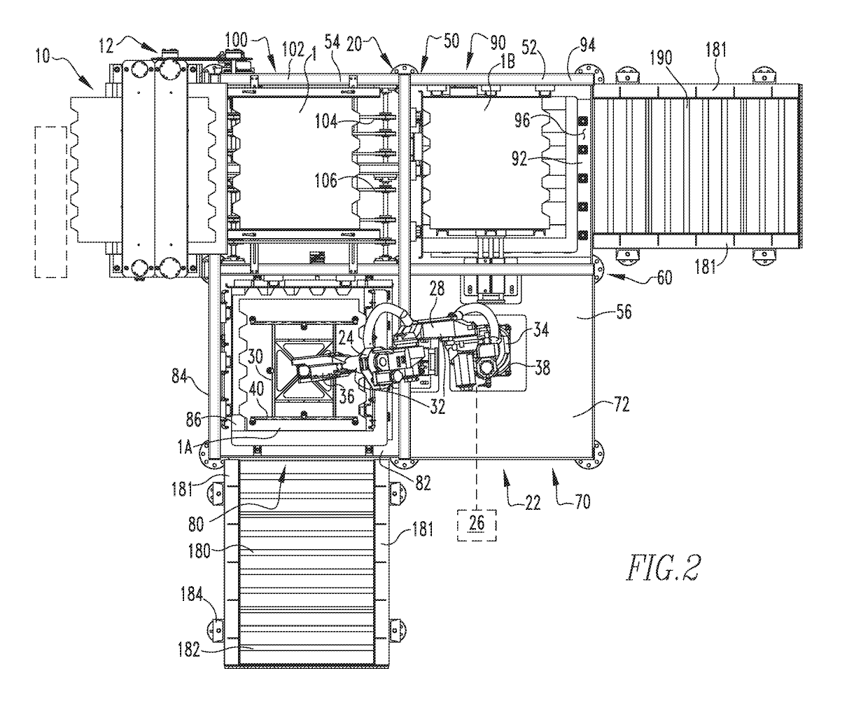

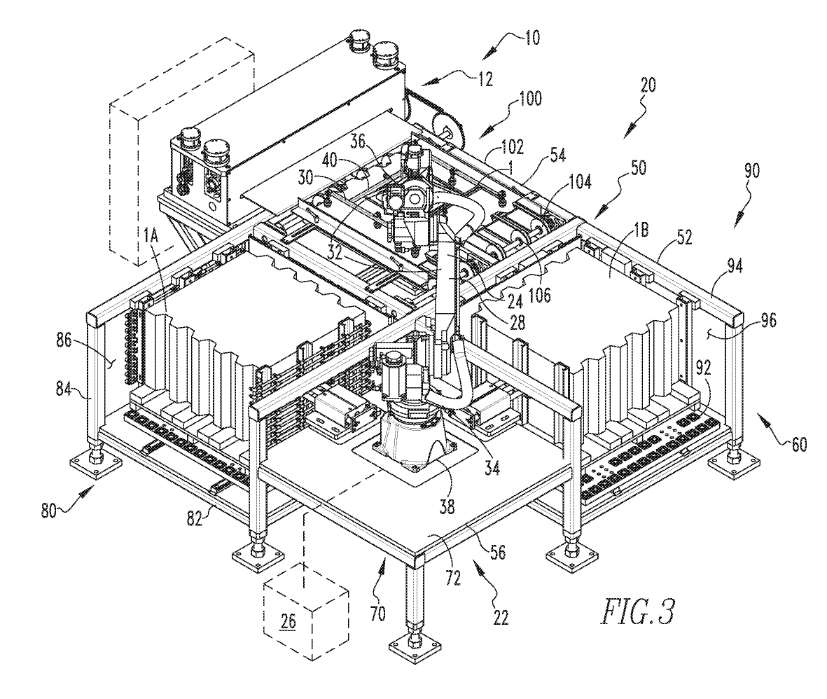

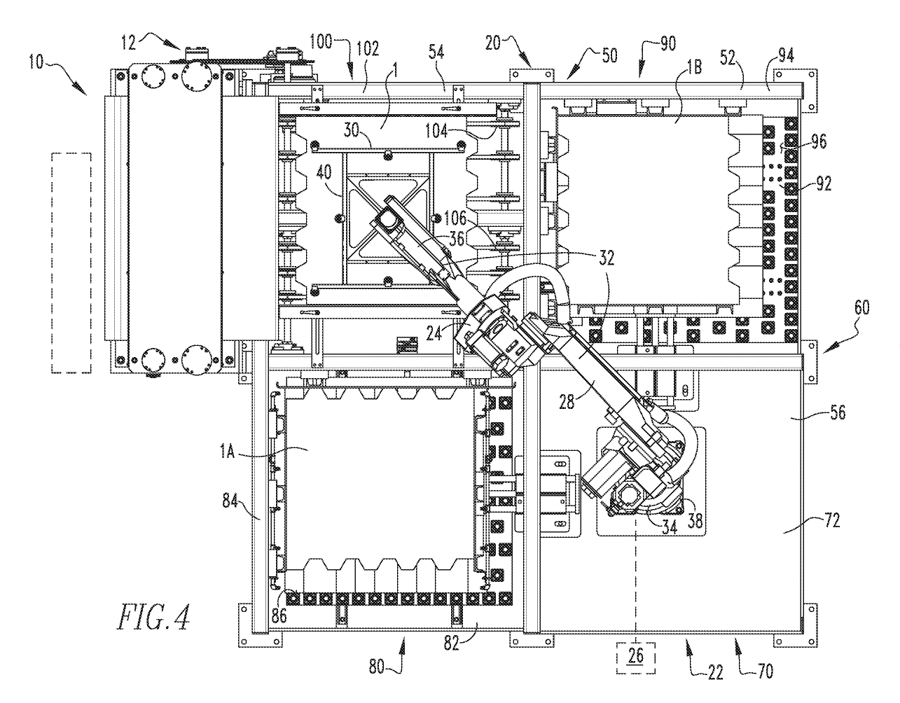

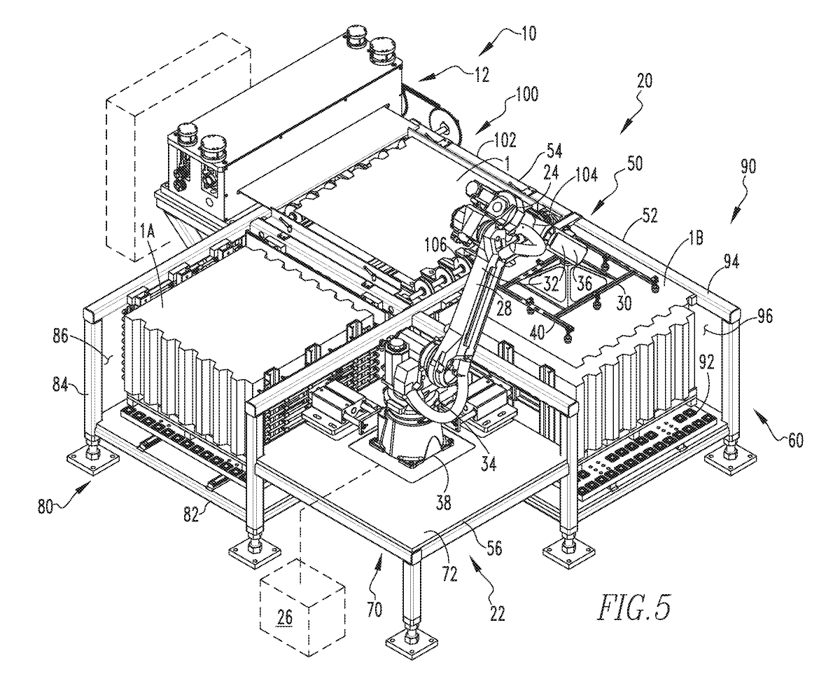

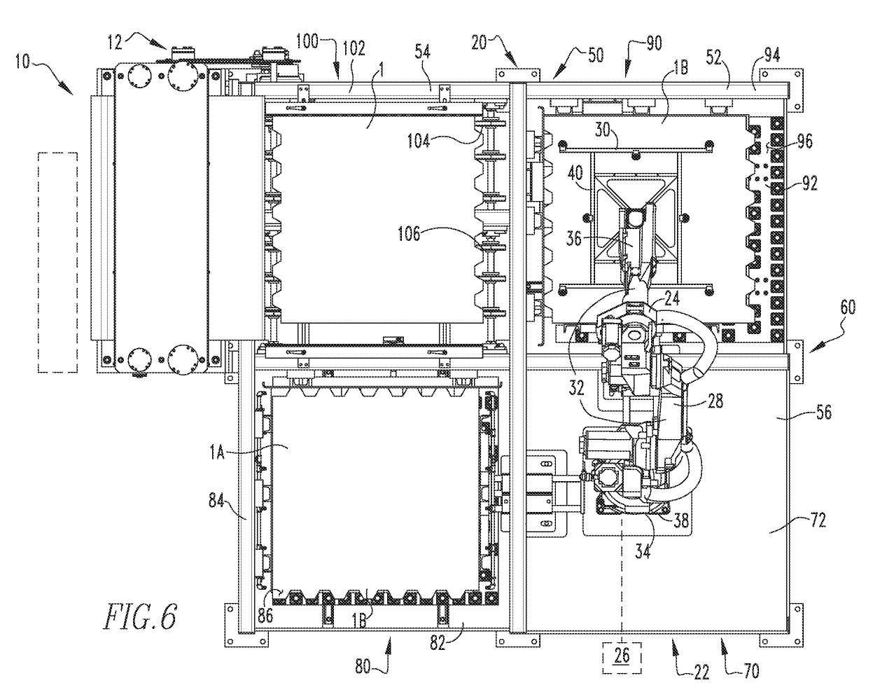

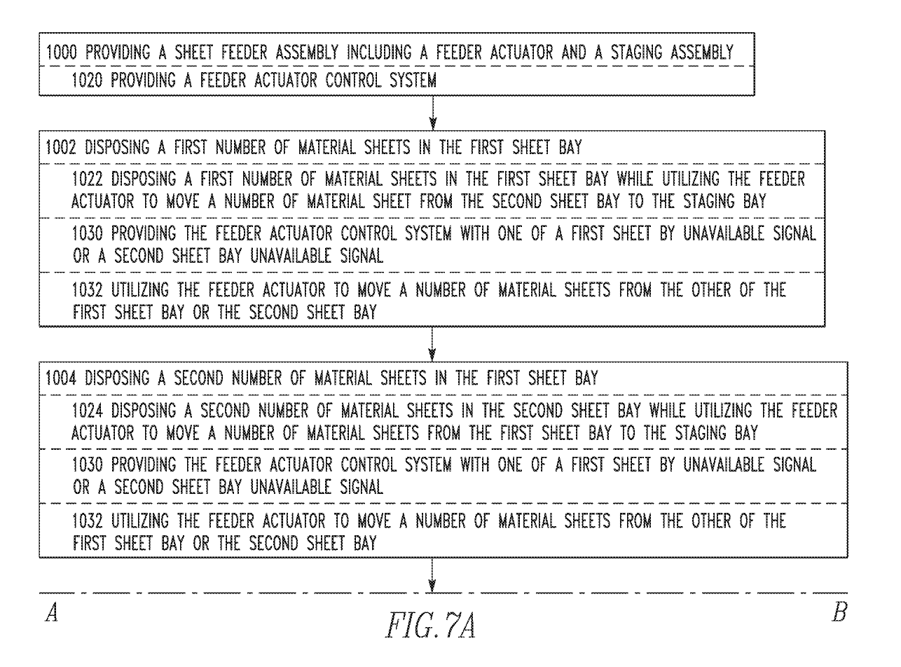

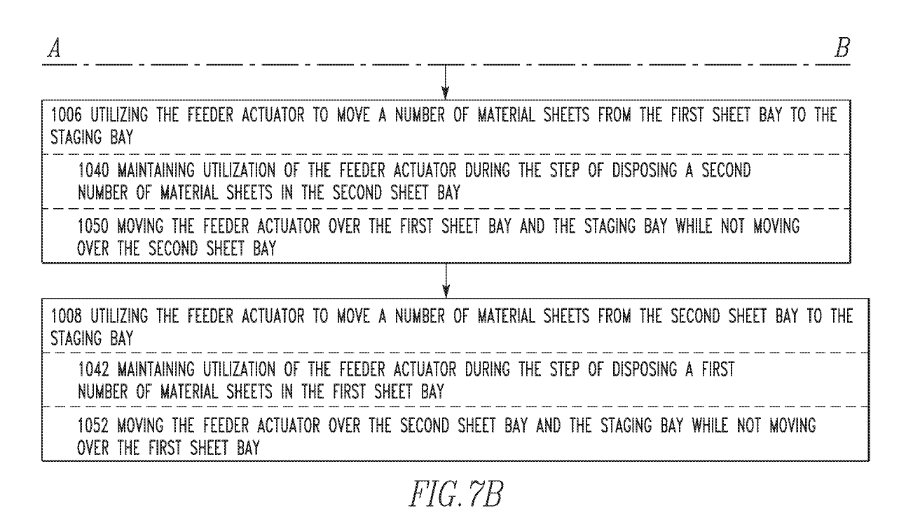

As shown in FIGS. 1-6, a shell press assembly 10, shown in partial schematic, includes an infeed 12 and a sheet feeder assembly 20. It is again noted that a shell press assembly 10 is exemplary and the disclosed sheet feeder assembly 20 may be used with any press that forms a sheet of material 1 into elements of a can. As is known, the infeed 12 is structured to transport a sheet of material 1, hereinafter “material sheet(s)” 1, to the forming stations, not shown, of the shell press assembly 10. As used herein, “material sheets” are generally planar members and specifically excludes other constructs such as cups and containers/boxes. In an exemplary embodiment, the material sheet(s) is metal, e.g., aluminum or steel. The sheet feeder assembly 20 is structured to temporarily hold or store a number of material sheets 1, and, to move the material sheets 1 to the infeed 12. In an exemplary embodiment, the material sheets 1 are moved one at a time to the infeed 12. It is understood that the material sheets 1 are generally planar elements that are disposed in a stack and material sheets 1 may, hereinafter be identified collectively as a “stack 1” or “stack of material sheets 1”.

The sheet feeder assembly 20 includes a multi-bay sheet feeder actuator 22 (hereinafter a “feeder actuator” 22) and a staging assembly 50. As used herein, the “multi-bay feeder actuator” 22 (or “feeder actuator” 22) is a discrete unit structured to operatively engage material sheets 1 from, or in, separate bays 80, 90, 100 (described below). That is, for example, a system having two bays and two feeder conveyors with one feeder conveyor associated with each bay does not include a “multi-bay feeder actuator” as defined herein. Further, as used herein, a “multi-bay sheet feeder actuator” 22 (or “feeder actuator” 22) is structured to manipulate planar members and specifically excludes an actuator structured to manipulate constructs such as cups or non-planar containers/boxes.

In an exemplary embodiment, the feeder actuator 22 is a robotic feeder actuator 24. That is, the feeder actuator 22 includes a feeder actuator control system 26 (shown schematically), an arm assembly 28, an end effector 30 and a mounting 38. The feeder actuator control system 26 is structured to control and track the configuration of the arm assembly 28 and end effector 30. The arm assembly 28 includes a number of rigid arm members 32 with each arm member 32 movably coupled to the adjacent arm member(s) 32. The arm assembly 28 includes a proximal end 34 and a distal end 36. The arm assembly proximal end 34 is coupled, directly coupled, or fixed to a mounting 38. The end effector 30 is coupled to the arm assembly distal end 36. The end effector 30 is structured to move the material sheet 1. In an exemplary embodiment, the end effector 30 is structured to move an individual sheet of material sheet 1 at a time. In an exemplary embodiment, the end effector 30 includes a number of magnetic elements 40 structured to be selectively magnetically coupled to a ferrous material sheet 1A. That is, the magnetic elements 40 are structured to be selectively magnetized and demagnetized. In another exemplary embodiment, not shown, the end effector 30 includes a number of suction couplings that are structured to be selectively coupled to a material sheet 1. That is, the suction couplings are structured to be selectively actuated so as to apply suction to a generally flat surface.

The feeder actuator 22, and in an exemplary embodiment, the robotic feeder actuator 24, is structured to operatively engage individual material sheets 1, i.e., one material sheet 1 at a time, and to move the material sheet 1. Thus, as defined above, each of the material sheet 1, the end effector 30 and the feeder actuator 22 each have a path of travel, or path. It is noted that, as the end effector 30 is a sub-assembly of the feeder actuator 22, the paths are partially coextensive. As is known, robotic assemblies, such as, but not limited to robotic arms, require a zone of safety so that people do not move into the path of travel of a robotic assembly. Further, and as is known, people are not likely to climb onto an assembly having a robotic assembly and, as such, people typically walk into a robotic assembly's path of travel when the robotic assembly is occupying another portion of its path of travel. Thus, as used herein, a “safe path” or “safe path of travel” is a path of travel that extends substantially over an occupied floor space. That is, if the floor space is occupied by an object, such as but not limited to a staging assembly 50, a person is not likely to move into that space and, therefore, not likely to move into the path of travel of the robotic assembly. As discussed further below, the path of travel for the material sheet 1, the end effector 30 and the feeder actuator 22 are structured to be, and are, safe paths.

The staging assembly 50 includes a number of rigid members 52. In an exemplary embodiment, the rigid members 52 are elongated frame members 54 and planar members 56 that define a frame assembly 60, hereinafter “staging assembly frame assembly” 60, and, in an exemplary embodiment, the feeder table frame assembly 160, described below. The staging assembly frame assembly 60 further defines a number of “bays.” As used herein, a “bay” is an area of the staging assembly frame assembly 60 that serves a specific purpose and which is generally separated from other “bays” by frame members 54 or other constructs. In an exemplary embodiment, the staging assembly frame assembly 60 defines a support bay 70, a first sheet bay 80, a second sheet bay 90, and a staging bay 100. Further, as used herein, a “sheet bay” is structured to support generally planar members.

That is, the support bay 70 includes a generally horizontal planar member 72. The feeder actuator mounting 38 is coupled, directly coupled, or fixed to the support bay 70 and, in an exemplary embodiment, to the support bay planar member 72. It is understood that elements of the feeder actuator 22, including the end effector 30, operate beyond the perimeter of the support bay 70. This does not change the nature of the support bay 70 as a “bay” as defined above. That is, the specific purpose of the support bay 70 is to support the feeder actuator 22.

The first sheet bay 80 and second sheet bay 90 are substantially similar and only the first sheet bay 80 is described. It is understood that the second sheet bay 90 includes similar elements that may be identified by similar reference numbers +10. That is, for example, the first sheet bay 80 includes a generally horizontal planar member 82 and frame members 84 defining a generally enclosed space 86, described below. Thus, the second sheet bay 90 includes a generally horizontal planar member 92 and frame members 94 defining a generally enclosed space 92. Further, as used herein, a “sheet bay” is structured to temporarily support material sheets 1 and is not structured to support such as cups or non-planar containers/boxes.

In an exemplary embodiment, the first sheet bay planar member 82 is supported above the ground, or other substrate, by the first sheet bay frame members 84. The first sheet bay frame members 84 further extend generally upwardly from the perimeter of the first sheet bay planar member 82 thereby defining the first sheet bay enclosed space 86. The first sheet bay enclosed space 86 is open on the top and on one side. The first sheet bay 80 also includes a linear rail system 87 for squaring the stack of material sheets 1A. The linear rail system 87 includes a linear motor 88 and a rail assembly including sets of opposed rails 89A, 89B. The linear motor 88 includes a linear actuator 85. One set of rails 89A is coupled, directly coupled, or fixed to the staging assembly frame assembly 60 and the other set of rails 89B is coupled, directly coupled, or fixed to the linear actuator 85. Further, in an exemplary embodiment, the linear rail system 87 includes a second pneumatically driven guide (not shown) which will square the stack against a second edge of the staging assembly frame assembly 60 or another set of rails (not shown). Further, in an exemplary embodiment, the linear rail system 87 includes a table composed of uni-direction rollers (not shown) that assist in squaring material sheets 1A. In this configuration, the first sheet bay 80 is structured to temporarily support a first number of material sheets 1A. Similarly, the second sheet 90 is structured to temporarily support a second number of material sheets 1B.

The staging bay 100 is structured to move a material sheet 1, and in an exemplary embodiment, an individual sheet of material sheet 1, from the staging bay 100, i.e., from the staging assembly 50, to the infeed 12. In an exemplary embodiment, the staging bay 100 includes frame elements 102 that support a conveyor assembly 104. As is known, the conveyor assembly 104 includes a number of belts 106, a motor, and a control assembly (neither shown). The conveyor assembly motor operatively engages the conveyor assembly belts 106. In one embodiment, the conveyor assembly belts 106 are in motion during the operation of the feeder actuator 22. Thus, once a material sheet 1 is deposited on the conveyor assembly belts 106, the material sheet 1 is moved out of the staging bay 100 and into the infeed 12. In another embodiment, the conveyor assembly control assembly is structured to actuate the conveyor assembly motor at selected times, or, when a material sheet 1 is disposed on the conveyor assembly belts 106. In this embodiment, when a material sheet is disposed on the conveyor assembly belts 106, the conveyor assembly motor is actuated causing the conveyor assembly belts 106 to move/transport the material sheet 1 out of the staging bay 100 and into the infeed 12.

In an exemplary embodiment, each of the bays 70, 80, 90, 100 are generally square when viewed from above. As such, the position or configuration of the bays 70, 80, 90, 100 is used to solve some of the problems related to the manipulation of sheet material 1 noted above. That is, the bays 70, 80, 90, 100 are configured so that each of the material sheets 1, the end effector 30 and the feeder actuator 22 travel over a safe path. That is, the first sheet bay 80 and the second sheet bay 90 are disposed in a “safe sheet bay configuration.” As used herein, a “safe sheet bay configuration” is a configuration wherein multiple sheet bays are disposed adjacent, and in an exemplary embodiment, immediately adjacent, the support bay 70. It is noted that a “safe sheet bay configuration” can only exist with a plurality of sheet bays 80, 90. That is, as used herein, bays for other constructs such as such as cups or containers/boxes cannot be in a “safe sheet bay configuration.”

For example, as shown and in an exemplary embodiment, the first sheet bay 80 is disposed adjacent, and in an exemplary embodiment, immediately adjacent, the support bay 70. That is, when the bays 70, 80, 90, 100 are generally square when viewed from above, the first sheet bay 80 is disposed adjacent, and in an exemplary embodiment, immediately adjacent, a lateral side of the support bay 70. Similarly, the second sheet bay 90 is disposed adjacent, and in an exemplary embodiment, immediately adjacent, the support bay 70. Again, when the bays 70, 80, 90, 100 are generally square when viewed from above, the second sheet bay 90 is disposed adjacent, and in an exemplary embodiment, immediately adjacent, another lateral side of the support bay 70.

Further, as shown, the staging bay 100 is disposed diagonally adjacent, i.e., “caddy corner” or “catty corner,” to the support bay 70. That is, when the bays 70, 80, 90, 100 are generally square when viewed from above, the staging bay 100 is diagonally adjacent, or diagonally immediately adjacent, to the support bay 70. Further, in this configuration, the first sheet bay 80 is disposed adjacent, or immediately adjacent, the staging bay 100, and, the second sheet bay 90 is disposed adjacent, or immediately adjacent, the staging bay 100. That is, the first sheet bay 80 is disposed adjacent, or immediately adjacent, a lateral side of the staging bay 100, and, the second sheet bay 90 is disposed adjacent, or immediately adjacent, another lateral side of the staging bay 100. As used herein, and when one element is disclosed as being disposed or located on “one side” of an elements, then “another” side means a side other than the “one side” associated with the first element discussed.

In this configuration, the sheet feeder assembly 20 is structured to, and does, operate as follows. A first number of material sheets 1, and in an exemplary embodiment, a first plurality of material sheets 1, are temporarily disposed in the first sheet bay 80. Similarly, a second plurality of material sheets 1, are temporarily disposed in the second sheet bay 90. It is understood that the material sheets 1, during transport, may be bound so as to prevent the material sheets from sliding relative to each other. When the material sheets 1 are disposed in the first sheet bay 80 and the second sheet bay 90, the material sheets are unbound and are, therefore, “temporarily disposed” in the first sheet bay 80 and the second sheet bay 90. Thus, individual sheets are free to be lifted off of the stack of material sheets 1.

The feeder actuator 24 moves a material sheet 1 from the first sheet bay 80 to the staging bay 100. As the staging bay 100 moves the material sheet 1 to the infeed 12, the feeder actuator 24 returns to the first sheet bay 80 to operatively engage another material sheet 1 and then moves that material sheet 1 to the staging bay 100. Thus, the material sheet 1, the end effector 30 and the feeder actuator 22 each moves over, i.e., has, a first path that extends from the first sheet bay 80 to the staging bay 100. In the exemplary embodiment as shown, the path of the material sheet 1, the end effector 30 and the feeder actuator 22 extends substantially over, i.e., above, the first sheet bay 80 to the staging bay 100. Because a person cannot walk into the area occupied by the first sheet bay 80 and the staging bay 100, the first path is a safe path. The feeder actuator 22 interacts with the second sheet bay 90 in a similar manner. Thus, the feeder actuator 22 also has second path, i.e., a second path for the material sheet(s) 1, the end effector 30 and the feeder actuator 22 that extends substantially over, i.e., above, the second sheet bay 90 and the staging bay 100. Thus, the second path is a safe path as well. That is, the second path also extends above an area occupied by the second sheet bay 90 and the staging bay 100.

In another embodiment, not shown, the sheet bays are stacked on each other, or, are structured to feed material sheets 1 from the bottom of the bay. Thus, the feeder actuator 22 first path and feeder actuator 22 second path are disposed adjacent to the first sheet bay 80 and the staging bay 100, and, the second sheet bay 90 and the staging bay 100, respectively. That is, as used herein, and in respect to paths of travel, “adjacent” is a broader term that encompasses “above.”

As the feeder actuator 22 first path and feeder actuator 22 second path are safe paths, due to the configuration of the bays 70, 80, 90, 100 as described above, the disclosed configuration of bays 70, 80, 90, 100 solves the problems stated above.

Further, the movement of material sheets 1 from the first sheet bay 80 to the staging bay 100 is repeated until the first sheet bay 80 is empty. The feeder actuator 22 then starts to move material sheets 1 from the second sheet bay 90. Because the second path is a safe path, technicians are able to safely refill the first sheet bay 80. Similarly, when the second sheet bay 90 is empty, the feeder actuator 22 again moves material sheets 1 from the first sheet bay 80. Further, because the first path is also a safe path, the technicians are able to safely refill the second sheet bay 90. Thus, in this configuration, the sheet feeder assembly 20, and therefore the shell press assembly 10 are in constant operation. As used herein, “constant operation” means that a device, and in this disclosure the feeder actuator 22, is in operation during a time a sheet bay 80, 90 of the staging assembly 50 is refilled with material sheets 1, but, does not mean the device is in operation during maintenance or other down times.

The configuration disclosed above is exemplary. For example, in another embodiment, not shown, there are three sheet bays with the third sheet bay disposed caddy corner to the support bay 70 and adjacent, or immediately adjacent, the second sheet bay 90. As before, a single multi-bay feeder actuator 22 is structured to access all three sheet bays.

Further, in an exemplary embodiment, the staging assembly 50 also includes a feeder table 180, 190, shown in FIGS. 1 and 2, for each sheet bay 80, 90. Each feeder table 180, 190 includes a frame assembly 160, hereinafter “feeder table frame assembly” 160.

As with the sheet bays, 80, 90, the feeder table 180, 190 are substantially similar and only one will be described. Also as with the staging assembly frame assembly 60, the feeder table frame assembly 160 includes a plurality of rigid members 52 which, as described above include frame members 54 and planar members 56. In an exemplary embodiment, each feeder table frame assembly 160 includes a feeder table planar member 182 is supported above the ground, or other substrate, by feeder table frame members 184. The feeder table planar member 182 is supported above the ground substantially corresponding to the elevation of the associated sheet bay planar member 82, 92. Each feeder table frame assembly 160 also includes a number of guide members 181 disposed on opposite sides of the feeder table planar member 182. The feeder table frame assembly guide members 181 are not disposed on the side of the feeder table planar member 182 immediately adjacent the sheet bay planar member 82, 92. In this configuration, the feeder table frame assembly guide members 181 define, i.e. limit the path of travel of a stack of material sheets 1 disposed thereon.

In operation, a stack of material sheets 1 is temporarily disposed on each feeder table 180, 190. During this time, the stack of material sheets 1 is inspected and any bundling devices, such as, but not limited to, straps (not shown), are removed. The stack of material sheets 1 is then moved to the associated sheet bay 80, 90. Use of the feeder tables 180, 190 further limit the space in which a user may stand or otherwise occupy. Thus, a user is further spaced from the path of travel of the feeder actuator 22. Thus, the feeder tables 180, 190 also solve the problems stated above.

Accordingly, a method associated with the shell press assembly 10 described above includes the following. Providing 1000 a sheet feeder assembly 20 including a feeder actuator 22 and a staging assembly 50, the staging assembly 50 including a staging assembly frame assembly 60, the staging assembly frame assembly 60 defining a first sheet bay 80, a second sheet bay 90, and a staging bay 100, the first sheet bay 80 structured to temporarily support a first number of material sheets 1, the second sheet bay 90 structured to temporarily support a second number of material sheets 1, and wherein the feeder actuator 22 is movably coupled to the staging assembly 50, disposing 1002 a first number of material sheets 1 in the first sheet bay 80, disposing 1004 a second number of material sheets 1 in the second sheet bay 80, utilizing 1006 the feeder actuator 22 to move a number of material sheets 1 from the first sheet bay 80 to the staging bay 100, and utilizing 1008 the feeder actuator 22 to move a number of material sheets 1 from the second sheet 90 bay to the staging bay 100. Hereinafter, “providing 1000” the elements identified above is identified as “providing 1000 a sheet feeder assembly 20.” Further, it is understood that, other than providing 1000 a sheet feeder assembly 20, the other actions may be repeated.

Further, disposing 1002 a first number of material sheets 1 in the first sheet bay 80 includes disposing 1022 a first number of material sheets 1 in the first sheet bay 80 while utilizing the feeder actuator 22 to move a number of material sheets 1 from the second sheet bay 90 to the staging bay 100. Similarly, disposing 1004 a second number of material sheets in the second sheet bay includes disposing 1024 a second number of material sheets 1 in the second sheet bay 90 while utilizing the feeder actuator 22 to move a number of material sheets 1 from the first sheet bay 80 to the staging bay 100. That is, each sheet bay 80, 90 is reloaded while the feeder actuator 22 is being utilized and using the other bay 80, 90.

In another embodiment, providing 1000 a sheet feeder assembly 20, as well as the elements noted above, also includes providing 1020 a feeder actuator control system 26. In this embodiment, the feeder actuator control system 26 (shown schematically) is structured to receive a first sheet bay unavailable signal and a second sheet bay unavailable signal. The first sheet bay unavailable signal and the second sheet bay unavailable signal are signals generated by sensors, not shown, such as, but not limited to, weight sensors in each sheet bay 80, 90. In another embodiment, each sheet bay 80, 90 includes a proximity sensor (not shown) structured to detect when the stack height has dropped to a predetermined level.

Alternatively, or in addition to the sensors, the first sheet bay unavailable signal and the second sheet bay unavailable signal are generated by a manual input. For example, if a technician observes that the material sheets 1 in the first sheet bay 80 are damaged, a manual input device, e.g., a button (not shown) on the feeder actuator control system 26 is actuated and the first sheet bay unavailable signal is generated and provided to the feeder actuator control system 26. Thus, the feeder actuator control system 26 is structured to the utilize the feeder actuator 22 to move material sheets 1 from the second sheet bay 90 in response to receiving the first sheet bay unavailable signal. Similarly, the feeder actuator control system 26 is structured to utilize the feeder actuator 22 to move material sheets 1 from the first sheet bay 80 in response to receiving the second sheet bay unavailable signal. In this embodiment, utilizing 1006 the feeder actuator 22 to move a number of material sheets 1 from the first sheet bay 80 to the staging bay 100, and, utilizing 1008 the feeder actuator 22 to move a number of material sheets 1 from the second sheet bay 90 to the staging bay 100 includes: providing 1030 the feeder actuator control system 26 with one of a first sheet bay unavailable signal or a second sheet bay unavailable signal, and utilizing 1032 the feeder actuator 22 to move a number of material sheets 1 from the other of the first sheet bay 80 or the second sheet bay 90. As used herein, “utilizing 1032 the feeder actuator 22 to move a number of material sheets 1 from the other of the first sheet bay 80 or the second sheet bay 90” means that, if the feeder actuator control system 26 is provided with a first sheet bay unavailable signal, the “other” of the first sheet bay 80 or the second sheet bay 90 is the second sheet bay 90. Conversely, if the feeder actuator control system 26 is provided with a second sheet bay unavailable signal, the “other” of the first sheet bay 80 or the second sheet bay 90 is the first sheet bay 90. That is, the feeder actuator control system 26 is structured to switch the feeder actuator 22 from moving material sheet 1 from the first/second sheet bay 80, 90 to the “other” sheet bay 80, 90, upon being provided a first/second sheet bay unavailable signal.

In another alternate embodiment, utilizing 1006 the feeder actuator 22 to move a number of material sheets 1 from the first sheet bay 70 to the staging bay 100 also includes maintaining 1040 utilization of the feeder actuator 22 during the step of disposing 1004 a second number of material sheets 1 in the second sheet bay 90. That is, utilizing 1006 while the feeder actuator 22 to move a number of material sheets 1 from the first sheet bay 80 to the staging bay 100, the action of disposing 1004 a second number of material sheets 1 in the second sheet bay 90 is also performed. Similarly, utilizing 1008 the feeder actuator 22 to move a number of material sheets 1 from the second sheet 90 bay to the staging bay 100 includes maintaining 1042 utilization of the feeder actuator 22 during the step of disposing 1002 a first number of material sheets 1 in the first sheet bay 80.

In another embodiment, utilizing 1006 the feeder actuator 22 to move a number of material sheets 1 from the first sheet bay 80 to the staging bay 100 also includes moving 1050 the feeder actuator 22 over the first sheet bay 80 and the staging bay 100 while not moving over the second sheet bay 90. Thus, a technician is generally safe when working on or refilling the second sheet bay 90. Similarly, utilizing 1008 the feeder actuator 22 to move a number of material sheets 1 from the second sheet 90 bay to the staging bay 100 includes moving 1052 the feeder actuator 22 over the second sheet bay 90 and the staging bay 100 while not moving over the first sheet bay 80.

Operating the shell press assembly 10 as detailed above solves the problems stated above.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. (canceled)

2. The staging assembly of claim 5 wherein:
the first sheet bay and the staging bay disposed adjacent the feeder actuator first path; and
the second sheet bay and the staging bay disposed adjacent the feeder actuator second path.

3. (canceled)

4. (canceled)

5. A staging assembly for a shell press assembly sheet feeder assembly, the shell press assembly including an infeed and the sheet feeder assembly, the sheet feeder assembly including a feeder actuator, the feeder actuator having a first path and a second path, the staging assembly comprising:
a staging assembly frame assembly defining a first sheet bay, a second sheet bay, a support bay, and a staging bay;
the first sheet bay structured to temporarily support a first number of material sheets;
the second sheet bay structured to temporarily support a second number of material sheets;
the support bay structured to support the feeder actuator;
the first sheet bay disposed immediately adjacent the support bay;
the second sheet bay disposed immediately adjacent the support bay;
the first sheet bay disposed immediately adjacent the staging bay; and
the second sheet bay disposed immediately adjacent the staging bay.

6. The staging assembly of claim 5 wherein the staging bay is structured to move a sheet from the staging bay to the infeed.

7. (canceled)

8. The sheet feeder assembly of claim 11 wherein:
the first sheet bay and the staging bay disposed adjacent the feeder actuator first path; and
the second sheet bay and the staging bay disposed adjacent the feeder actuator second path.

9. (canceled)

10. (canceled)

11. A sheet feeder assembly for a shell press assembly, the shell press assembly including an infeed, the sheet feeder assembly comprising:
a feeder actuator;
a staging assembly;
the staging assembly including a staging assembly frame assembly;
the staging assembly frame assembly defining a first sheet bay, a second sheet bay, a support bay, and a staging bay;
the first sheet bay structured to temporarily support a first number of material sheets;
the second sheet bay structured to temporarily support a second number of material sheets;
the support bay structured to support the feeder actuator;
the first sheet bay disposed immediately adjacent the support bay;
the second sheet bay disposed immediately adjacent the support bay;
the first sheet bay disposed immediately adjacent the staging bay; and
the second sheet bay disposed immediately adjacent the staging bay.

12. The sheet feeder assembly of claim 11 wherein the staging bay is structured to move a sheet from the staging bay to the infeed.

13. A method of feeding material sheets to a shell press assembly, the shell press assembly including an infeed, the method comprising:
providing a sheet feeder assembly including a feeder actuator and a staging assembly, the staging assembly including a staging assembly frame assembly, the staging assembly frame assembly defining a first sheet bay, a second sheet bay, a support bay, and a staging bay, the first sheet bay structured to temporarily support a first number of material sheets, the second sheet bay structured to temporarily support a second number of material sheets, the support bay structured to support the feeder actuator, the first sheet bay disposed immediately adjacent the support bay, the second sheet bay disposed immediately adjacent the support bay, the first sheet bay disposed immediately adjacent the staging bay, and the second sheet bay disposed immediately adjacent the staging bay, and wherein the feeder actuator is movably coupled to the staging assembly;
disposing a first number of material sheets in the first sheet bay;
disposing a second number of material sheets in the second sheet bay;
utilizing the feeder actuator to move a number of material sheets from the first sheet bay to the staging bay; and
utilizing the feeder actuator to move a number of material sheets from the second sheet bay to the staging bay.

14. The method of claim 13 wherein the disposing a first number of material sheets in the first sheet bay includes disposing a first number of material sheets in the first sheet bay while utilizing the feeder actuator to move a number of material sheets from the second sheet bay to the staging bay.

15. The method of claim 14 wherein the disposing a second number of material sheets in the second sheet bay includes disposing a second number of material sheets in the second sheet bay while utilizing the feeder actuator to move a number of material sheets from the first sheet bay to the staging bay.

16. The method of claim 13 wherein providing a sheet feeder assembly, utilizing the feeder actuator to move a number of material sheets from the first sheet bay to the staging bay, and the utilizing the feeder actuator to move a number of material sheets from the second sheet bay to the staging bay includes:
providing a feeder actuator control system, the feeder actuator control system structured to receive a first sheet bay unavailable signal and a second sheet bay unavailable signal, the feeder actuator control system structured to the utilize the feeder actuator to move material sheets from the second sheet bay in response to receiving the first sheet bay unavailable signal, and, the feeder actuator control system structured to utilize the feeder actuator to move material sheets from the first sheet bay in response to receiving the second sheet bay unavailable signal;
providing the feeder actuator control system with one of a first sheet bay unavailable signal or a second sheet bay unavailable signal; and
utilizing the feeder actuator to move a number of material sheets from the other of the first sheet bay or the second sheet bay.

17. The method of claim 13 wherein utilizing the feeder actuator to move a number of material sheets from the first sheet bay to the staging bay includes maintaining utilization of the feeder actuator during the step of disposing a second number of material sheets in the second sheet bay.

18. The method of claim 17 wherein utilizing the feeder actuator to move a number of material sheets from the second sheet bay to the staging bay includes maintaining utilization of the feeder actuator during the step of disposing a first number of material sheets in the first sheet bay.

19. The method of claim 13 wherein utilizing the feeder actuator to move a number of material sheets from the first sheet bay to the staging bay includes moving the feeder actuator over the first sheet bay and the staging bay while not moving over the second sheet bay.

20. The method of claim 13 wherein utilizing the feeder actuator to move a number of material sheets from the second sheet bay to the staging bay includes moving the feeder actuator over the second sheet bay and the staging bay while not moving over the first sheet bay.

21. The staging assembly of claim 5 wherein:
the first sheet bay is disposed diagonally adjacent the second sheet bay; and
the support bay is disposed diagonally adjacent the staging bay.

22. The staging assembly of claim 5 further including a feeder table disposed adjacent the first sheet bay.

23. The staging assembly of claim 22 wherein:
the first sheet bay includes a planar member, the first sheet bay planar member disposed above the ground; and
the feeder table disposed above the ground at an elevation substantially corresponding to the elevation of the first sheet bay planar member.

24. The sheet feeder assembly of claim 11 wherein:
the first sheet bay is disposed diagonally adjacent the second sheet bay; and
the support bay is disposed diagonally adjacent the staging bay.

25. The sheet feeder assembly of claim 11 further including a feeder table disposed adjacent the first sheet bay.

26. The sheet feeder assembly of claim 25 wherein:
the first sheet bay includes a planar member, the first sheet bay planar member disposed above the ground; and
the feeder table disposed above the ground at an elevation substantially corresponding to the elevation of the first sheet bay planar member.
